(19) United States
(12) Patent Application Publication
(10) Pub. No.: US 2014/0037213 A1
(43) Pub. Date: Feb. 6, 2014

(54) IMAGE PROCESSING

(71) Applicants: Christoph Niederberger, Basel (CH); Stephan Wurmlin Stadler, Zurich (CH); Remo Ziegler, Uster (CH); Marco Feriencik, Zurich (CH); Andreas Burch, Steinen (CH); Urs Donni, Winterthur (CH); Richard Keiser, Zurich (CH); Julia Vogel Wenzin, Zurich (CH)

(72) Inventors: Christoph Niederberger, Basel (CH); Stephan Wurmlin Stadler, Zurich (CH); Remo Ziegler, Uster (CH); Marco Feriencik, Zurich (CH); Andreas Burch, Steinen (CH); Urs Donni, Winterthur (CH); Richard Keiser, Zurich (CH); Julia Vogel Wenzin, Zurich (CH)

(73) Assignee: LIBEROVISION AG, Zurich (CH)

(21) Appl. No.: 14/110,790

(22) PCT Filed: Apr. 2, 2012
(86) PCT No.: PCT/CH12/00077

§ 371 Date: Oct. 18, 2013

Related U.S. Application Data
(60) Provisional application No. 61/473,870, filed on Apr. 11, 2011.

(51) Int. Cl. G06K 9/00

(52) U.S. Cl. CPC G06K 9/00624
USPC 382/195

(57) ABSTRACT

A method of processing image data includes providing an image sequence such as a video sequence, or a camera transition, identifying a region-of-interest in at least one image of the image sequence, defining a transition region around the region-of-interest and defining a remaining portion of the image to be a default region or background region, applying different image effects to the region-of-interest, the transition region and the background region.

### BACKGROUND OF THE INVENTION

1. Field of the Invention

The invention is in the field of processing image data, for example with the aim of generating visual effects, and/or with the aim of treating (temporarily) relevant data different from (temporarily) irrelevant data.

2. Description of Related Art

Several approaches exist to change perspectives and generate virtual viewpoints based on imagery recorded by TV-cameras. To minimize visual artefacts and create the best rendering result, various geometric representations and rendering algorithms are known.

For example, virtual viewpoints for sport scenes for example of television have been done according to a first option by using deformed 3D template meshes with pre-stored textures. The final rendering, in accordance with this option, is a completely virtual scene, where actors/players as well as the surroundings (e.g. stadium) are rendered this way.

According to a second option, this is done by using deformed 3D template meshes with pre-stored textures on a background, which is based on an approximate geometry of the surroundings using textures from the real cameras.

In accordance with a third option, the virtual viewpoints have been implemented by using approximate geometry and textures taken from the real camera images. This representation is then used for all the objects of the scene.

A further issue in image processing is generating visual effects, for example for camera transitions. A camera transition is a transition between camera images from two cameras, wherein the camera images can be the same during the entire transition or can change during the transition. In this, the cameras may be real or virtual cameras. Camera transitions with synthetic images and video sequences, generated for virtual cameras, are described, for example in US 2009/0315978.

Image effects are also used to convey motion or alter the perception of an image by transforming a source image based on this effect. Possible effects are motion blur, depth of field, color filters and more. These kinds of image effects are used in the movie industry for computer generated movies, or post processing effects.

The image effects for camera transitions can be divided in different categories:
a. 2D Transition without geometry: Countless transition effects blend from picture to picture or 2D video to 2D video, by blurring, transforming, warping, or animating 3D particles. These are part of the classic video transitions available in commercial packages such as in Adobe After Effects, Final Cut Pro, or Avid Xpress. The effects are, however, not making use of the scene geometry of the scene depicted on the video or picture and are not basing the transition on a change in viewpoint from the scene.
b. Camera transition with approximate scene geometry: Image effects for camera transitions generating an image using an approximate geometry of the scene are used to increase the perception of fast camera movements (e.g. motion blur), or simulate camera effects, such as depth of field. These effects are applied in the same way to the entire scene. One approach to distinguish between objects to be blurred and objects not to be blurred is combining a motion blurred background with a non-motion blurred foreground. This way the foreground stands out, but appears to be detached from the background. Furthermore, the foreground object is only dependent on the cutout in the start and end position of the camera transition. Therefore, the foreground object is always on top of all the background objects.

Applying a spatially independent image effect to a camera transition does not allow controlling the effect spatially. Therefore, regions or objects, which should remain in the viewer's focus or should be handled differently, cannot be handled in a particular way. E.g. applying a motion blur on a camera transition might also blur the object, which should always remain recognizable for the viewer.

A known method applies the image effect to the background object but not to the foreground object (e.g. defined by a color based cutout). This is comparable to combining two separate images from the camera transitions, whereas one will not be modified by the image effect and the other one will be modified by the spatially independent image effect. In both cases the image effect is not spatially dependent, which results in a camera transition where the foreground object seems to be stitched on top of the background object.

### BRIEF SUMMARY OF THE INVENTION

Accordingly, it is an object of the present invention to provide methods overcoming drawbacks of prior art methods and especially of allowing seamless integration of image or scene parts to be handled specially into the entire image or scene.

In accordance with a first aspect of the invention, a method comprises the steps of
providing an image sequence, the image sequence for example being a video sequence, or a camera transition (of a constant image or of a video sequence),
identifying a region-of-interest (ROI) in at least one image of the image sequence,
defining a transition region around the region-of-interest and defining a remaining portion of the image to be a default region (or background region),
applying at least one image effect with at least one parameter to the region-of-interest (ROI) or the default region, (this includes the possibility of applying different image effects to the region-of-interest and the background region or of applying the same image effect to the ROI and the default region but with different parameters, and
applying the at least one image effect to the transition region with the at least one parameter being between a parameter value of the region-of-interest and a parameter value of the default region.

In the step of applying at least one image effect to the transition region, the image effect may be linearly or non-linearly blended between ‘close to the ROI’ and ‘close to the default region’. For example the parameter or at least one of the parameter may be a continuous, monotonous function of a position along a trajectory from the ROI to the default region through the transition region.

In this, it is understood that if an image effect is not applied to a certain region, this can be described by a particular parameter value (or particular parameter values) of this particular image effect, for example a parameter value of 0—depending on the representation.

In accordance with a second aspect of the invention, a method comprises the steps of
providing an image sequence, the image sequence for example being a video sequence, or a camera transition of a constant image or video sequence,
wherein the image sequence represents a scene, of which 3D data is available,
identifying a region-of-interest, for example by pointing it out in at least one image of the image sequence,
using the 3D data to identify the region-of-interest in images of the image sequence, (for example, if the region-of-interest was identified in a first image of the image sequence, the 3D data is used to identify the ROI in further images of the sequence (‘to keep track’), and/or the 3D image data may be used to define the ROI starting from a target (such as “ROI is a region around a certain player in a field”), and
applying at least one image effect to the region-of-interest (ROI) or the default region, (this includes the possibility of applying different image effects to the region-of-interest and the background region or of applying the same image effect to the ROI and the default region but differently, for example with different parameters).

In this, a transition region according to the first aspect may be present between the region-of-interest and the default region.

For example, the 3D data may comprise stereo disparity data (i.e. a relative displacement of a certain object in the image in images taken from different cameras, this depending on the distance of the object from the cameras), or may comprise a 3D position, a depth value, etc.; any data representing information on the 3D properties of the scene and being obtainable from camera images and/or from other data may be used.

The region-of-interest in the image data may be a 2D region-of-interest or a 3D region-of-interest.

A 2D region-of-interest is a region defined in the 2D image sequence, which region, however, in accordance with the second aspect is identified based on 3D data. For example, in a sports event, in the step of identifying a region-of-interest in at least one image of the image sequence, a certain player is chosen to be central to the region-of-interest. Then, in the image sequence, 3D data is used to identify objects (other players, a ball, etc.) that are close to the chosen player. Everything that is, in the 2D images of the image sequence, close to the object is then defined to belong to the region-of-interest.

Alternatively, the region-of-interest in the image data may be a 3D region-of-interest.

An example of a 3D ROI is as follows. To determine a 3D ROI, after choosing an object (for example a player) to belong to the ROI, a projection on a plane different from the normal to the line that connects this object with the (real or virtual) camera is made. An environment of the projection in this plane (for example a 5 m radius circle around the player's location) defines the ROI, which by definition comprises every object that is projected onto a region (the said environment) on said plane. A specific example is as follows. In an image sequence of a sports event, the location of a particular player is projected to the ground plane. A region on the ground plane around the player then defines the ROI, and every object that is in this region on the ground plane belongs to the ROI—independent on how far away this object is from the player in the actual camera image.

In accordance with the second aspect of the invention, it is proposed to use depth information of the scene for the image transition. This is in contrast with the prior art that does not consider any depth information of the scene. Nevertheless, merely an image effect is applied to the ROI and/or the default region (and if applicable to the transition region). An image effect is generally an effect applied to the 2D image(s). Thus it is not necessary to do a computationally extremely complex computation of a 3D model of the object to which the effect is applied (which laborious 3D model computation is sometimes applied to moving objects in animated pictures).

In accordance with a third aspect, a method for generating camera transitions or other image sequences based on a spatially adaptive image effect comprises of the following steps.
A. Determine the start and end camera of the transition, whereas they can also be the same (which latter case is an example of an other image sequence in which the image sequence consists of the video sequence itself; in the following this is viewed as degenerate camera transition with same start and end camera positions; in general all teaching applying to camera transitions herein can relate to real, non-degenerate camera transitions, to degenerate camera transitions or to both).
B. Create the camera transition. The camera transition from two cameras placed in space can be computed automatically. Optionally, automatically generated transition can be corrected by adding additional virtual views to the transition.
C. Define the ROI as mentioned above; this can be done prior to step A. and/or B., simultaneously or thereafter.
D. Provide at least one parameter for the image transition of the ROI, wherein optionally different parameters may be provided per element of the ROI. Different elements of the ROI are, for example, objects such as players, the playing field, markings on the playing field, etc.
E. Identify a default region and (if applicable) define the transition between the ROI and the default region.
F. Apply the image effect with the spatially adaptive parameter(s) according to the ROI and (if applicable) to the transition region.

The sequence of the steps may be from A. through F., or it may optionally be interchanged, however with step F. generally being the last of the mentioned steps.

In step F., the parameter(s) may be chosen to gradually vary through the transition region (as a function of position or speed, for example along a trajectory) from a value corresponding to the value in the ROI at the interface to the ROI to a value corresponding to the default region value at the interface to the default region. The gradual variation may for example be in function of a 3D distance from the ROI, of a distance projected onto a plane (such as the ground) or in function of a 2D distance in the image.

Alternatively, the parameter(s) may vary discontinuously or be constant in the transition region, for example somewhere between the ROI and default region values.

The third aspect of the invention may be implemented together with the first and/or second aspect of the invention.

In accordance with a fourth aspect, the method concerns a virtual camera transition from one perspective to another where the rendering of the virtual intermediate perspectives are altered based on one or more region(s) of interest (ROI), an ROI being a spatial function, with
“Perspective” meaning an image of a real or optionally virtual camera;
The “Spatial Function” or ROI being defined
   either in 2D on the virtual or real camera images
   or in 3D in the rendered scene
   and
   either static or dynamic over time
   and
   results in a projection onto the virtual camera image that labels pixels into two or three regions: “inside” (ROI), “transitional”, and “outside” (default region), where the transitional region can be inexistent.

“Altering” based on that spatial function means that [symbol]
In the “inside region” or in the “outside region”, one or a combination of image effects is applied. In this, inside region image effect(s) is/are not applied to the outside region or only applied to a lesser extent, and outside region image effect(s) is/are not applied to the inside region or only to a lesser extent. It is possible to combine inside region image effect(s) with outside region image effect(s).
The “transition region” can be used for example to decrease the effect for pixels being further away from the “inside” (for image effects applied to the “inside”) or closer to the “inside” (for image effects applied to the outside). Both, linear and non-linear transitions from inside to outside can be thought of.

A difference to prior art methods is that in accordance with the prior art, the whole virtual camera image would be “inside” or “outside” but not a combination, possibly including a transition.

The fourth aspect of the invention can be combined with the first, second, and/or third aspect of the invention.

In all aspects, there can be several ROI's and (if applicable) transition regions at the same time, with specific parameters each. The transition region (if any) starts with the border of the ROI and spreads to the default region or to the next ROI. If different ROIs are present, same or different image effects can be applied to the different ROIs and the transition regions (if any) around them. If same effects are applied to different ROIs, same or different parameter values can be used for the different ROIs.

Aspects of the invention may be viewed as a method of spatially adapting image effects, which is applied and combines a single or multiple images of a video or camera transition to one output image, to a 3D scene rendering or a stereoscopic image pair. A camera transition may be the generation of images as seen by a virtual camera when moving from one camera/position to another. The start and end camera/position can be static or moving to evaluate the transition. A moving start or end position can for example be given if the input is a video of a moving camera. The camera represents an image or video of a physical camera or viewpoint or view trajectory. The image or video can be a 2D image, a 2D video, a stereo image pair a stereo video stream or a 3D scene or animated 3D scene.

The spatial dependence of the image effect may mean that the image effect will be evaluated in a different way depending on the 3D location of the corresponding 3D position (this includes the possibility that to as 3D location information, or the corresponding depth of a stereo image point described by the disparity of an image point is used), or the 2D location of an image point.

Generally, aspects and embodiments may comprise the following concepts:
Using a spatially adaptive image effect for camera transitions. A spatially adaptive image effect allows seamlessly integrating regions of interests (ROI), which can be handled differently from the rest of the scene, without appearing borders or transitions between the ROI and non-ROI regions of the scene. Furthermore, multiple spatially dependent image effects can be applied and combined, with their respective ROI. In the above aspects, the transition region and the concept of identifying the ROI based on 3D data may both independently or in combination contribute to the spatially adaptive image effect making seamless integration possible.
The image effect can be adjusted for the ROI.
The ROI can optionally be defined by the user or based on some additional information not represented in the scene data. For example a user may, on an interactive screen, just encircle an object he would like to be the center of the ROI, etc.

In aspects and embodiments of the invention, the following characteristics are valid for the ROI:
1. The ROI is a set of 2D or 3D locations in an image or a scene.
2. The set describing the ROI does not in all embodiments have to consist of neighbouring 2D or 3D locations.
3. The set describing the ROI can change over time.

The following possibilities can for example be used to determine the ROI:
1. 2D Drawing of the ROI resulting in a default image filtering always at the same pixels of the resulting image.
2. The ROI can be automatically defined in a two-dimensional (real) camera image by depth continuities of the underlying scene (for example a player standing in the foreground), or an optical flow (the ROI is the moving object), or propagated segmentations (e.g., a once chosen ROI is propagated, for example by optical flow or tracking), propagated image gradients (an object standing out from the background is chosen and then followed, for example by optical flow or tracking), etc. The ROI in the actual (virtual) camera image during the camera transition is then for example a combination of all projections of the ROIs in their respective planes (n each case perpendicular to the viewing direction from the real camera) on the actual plane in 3D space (perpendicular to the viewing direction of the virtual camera, for example through the player); the combination can be a weighted average, where the views close from close to the virtual cameras have more weight than views from remote cameras.
3. Projecting a 2D drawing from any of the real (or possibly virtual) camera images into the scene resulting in a 3D ROI defined on the playing field.
4. 2D Drawing of the ROI in several cameras and 3D reconstruction of the ROI using visual hull or minimal surface.
5. Use a 3D model or function for the ROI.
6. Defining the ROI by selecting one or multiple objects as the ROI.
7. Defining a shape for the beginning and end of the transition and adjust the ROI during the transition.
8. Tracking a ROI over the entire transition.

This enumeration is not exhaustive. Combinations (as long as they are not contradictory) are possible, for example, any one of 1-5 can be combined with 7, etc.

A further, degenerate possibility of determining the ROI may be choosing the empty ROI, which results in a default image effect over the entire image, without transition regions. In most aspects and embodiments of the invention, a non-empty ROI is determined.

The image effect can be based on single or multiple 2D image effects, on single or multiple 3D based image effects or single or multiple stereo based 2D or 3D image effects. E.g. the image effect could also consist in a change of stereo disparity, which can be changed for a certain ROI resulting in one object of the scene appearing closer or further away during a camera transition.

A first example of an image effect is motion blur. For example, a plausible motion blur for the given camera transition may be applied. In a sports scene, if the camera transition is chosen in such a way, that the player, who should remain in focus of attention during the entire transition, features a relative motion on the transition images would result in a blurred appearance of this player. However, by defining a 3D ROI around this player, he can be kept in focus, although this would physically not have been the case.

A second example of an image effect is a motion blur with transition adjustment. The image effect can consist of a motion blur, which represents a plausible motion blur for the given camera transition. Again, a ROI can be defined around an object or a region, which should remain in focus. The ROI could, however, also be used to adjust the camera trajectory in order to minimize the travelled distance of pixels of the ROI during the camera transition. This results in a region/object appearing in focus, while correctly calculating motion blur for the entire image.

Depth of field: Instead of setting a fix focal length with a fix depth of field, the distance of the center of the ROI to the virtual camera can determine the focal length, while the radius of the ROI (for example projected on the ground plane) can be reflected as the depth of field. During the camera transition the image effect is being adjusted.

Enhance stereo images: A known image effect can transform a 2D video into a 3D stereo video. The perceived depth can then be increased by increasing disparity variance over the entire image. With the ROI, one could change the disparity locally, which allows making it appear to be closer or further away. This way the viewers' attention can be drawn to a specific object or region.

Embodiments of all aspects of the invention comprise building on approximate scene geometry and on a camera path used to generate virtual viewpoints being part of the images of the transition.

Embodiments of the invention may comprise the following features, alone or in combination. The features relate to all aspects of the invention unless otherwise stated:
The transition of two images or videos of two cameras, whereas the transition consists of the generated images while changing from one camera/position to the next. This could be a morph function, which describes the transition from one camera to the next or it can be the rendering of a scene from virtual viewpoints on any trajectory between the two cameras. If the transition is based on videos for the camera inputs, the images of the transition will also be a combination of the video frames, which are chosen based on the same time code. This allows having camera transitions, while the video is playing in a variable speed, allowing slow motion parts during a transition.
The transition can also be based on a single camera, whereas the transition is defined as all the frames lying in between the start frame and end frame. In this degenerate case, the transition corresponds to the video sequence itself.
The aforementioned images or videos (image sequences) can also be substituted by stereo images or stereo video.
Optionally the input can contain approximate information about the depth of the scene (for example derived using the information of further camera images and/or of a model etc.).
Optionally the input can contain the segmentation of a scene in different objects.
Optionally the input can contain the tracking of objects or regions in the scene.
Optionally the input can contain the calibration of the cameras.
The ROI can be defined by roughly encircling the ROI in the scene. An ellipse is fitted through the roughly encircled area and, for example, projected to the ground plane of the scene. The transition depends on the distance from the ellipse defining the ROI. After a given distance the image effect of the default region is applied.
The ROI can be defined by drawing an arbitrary shape, which is projected to the ground plane of the scene.
The ROI can be defined by all the objects, projected into the drawn area defined in a camera.
The ROI can be defined by drawing an arbitrary area in two images. The ROI is then defined by all 3D points of the scene, whose projection ends of in the encircled areas in both cameras.
The ROI can be defined relative to an object position or tracking position, where the shape of the object including a defined distance around it is defining the ROI.
The ROI can be defined by defining an arbitrary area of the image of the virtual camera.

Turning to embodiments of the image effect, the image effect can be an arbitrary effect, which is based on 2D images, 2D videos or stereo videos.
Optionally approximate information about the depth of the scene or scene geometry can be used.
Optionally the segmentation of a scene in different objects can be used.
Optionally the tracking of objects or regions in the scene can be used.
Optionally the calibration of the cameras can be used.

The implementation of the image effect can be any combination of the items above.

Possible image effects are:
Image effect 1: Motion blur: In an example, the input is an image (or video) per camera, the approximate scene geometry and the camera calibration. Based on the calibration and the scene geometry, a displacement of every pixel can be evaluated between two frames. The blur is evaluated by summing all pixels lying between the original position and the displaced one. This part of the motion blur may be viewed as velocity blur. Then, for an output video of X fps, one can accumulate all velocity blurred images, which are evaluated in 1/X of a second. The effect can optionally be exaggerated by accumulating more or less frames or by increasing or decreasing the displacement of the corresponding pixels in two images. These parameters could be adjusted for ROI, such that e.g. no motion blur is visible in the ROI.
Image effect 2: Depth of field: In an example, the input is an image (or video) per camera, the approximate scene geometry and the camera calibration. The distance of the center of the ROI is providing the focal length. The size of the ROI is providing the range of the depth of field, which shall be simulated. The depth of field is calculated by applying different kernel sizes, whereas the kernel size is directly correlated with the object's distance to the camera.
Image effect 3: Depth of field fix: In an example, the input is an image (or video) per camera, the approximate scene geometry and the camera calibration. The focal length and the depth of field are given. The resulting kernels to modify the image are adapted according to the ROI, where the objects of interest are set in focus, although they might not be in focus in the lens model used to generate the depth of field.
Image effect 4: Stereo enhancement: in an example, the input is a stereo image or stereo video per camera, and optionally the approximate scene geometry and the camera calibration. The entire depth range of the image can be increased or decreased by changing disparities. In the region-of-interest, the disparities are not uniformly scaled with the rest, allowing for some object to stand out in 3D (e.g. appearing closer to the viewer).
Image effect 5: Shading/brightening. The default region is shaded and/or the ROI is brightened to better bring out the ROI.

Again, these examples of image effects may, with the partial exception of effects 2 and 3, that are only partially compatible, arbitrarily combined.

In an embodiment, a computer program product for the processing image data according to the aspects described in the above, alone or in combination, is loadable into an internal memory of a digital computer or a computer system, and comprises computer-executable instructions to cause one or more processors of the computer or computer system execute the respective method. In another embodiment, the computer program product comprises a computer readable medium having the computer-executable instructions recorded thereon. The computer readable medium preferably is non-transitory; that is, tangible. In still another embodiment, the computer program is embodied as a reproducible computer-readable signal, and thus can be transmitted in the form of such a signal.

The method can be performed by computer system comprising, typically, a processor, short- and long-term memory storage units and at least one input/output device such as a mouse, trackball, joystick, pen, touchscreen, display unit etc.

### BRIEF DESCRIPTION OF THE DRAWINGS

The subject matter of the invention will be explained in more detail in the following text with reference to exemplary embodiments which are illustrated in the attached drawings, in which:

FIG. 1 is a schematic that shows an image of a scene in a game, with different image effects applied to different parts of the image; and

FIGS. 2-4 are different real images of scenes in a game, with different image effects applied to different parts of the images.

### DETAILED DESCRIPTION OF THE INVENTION

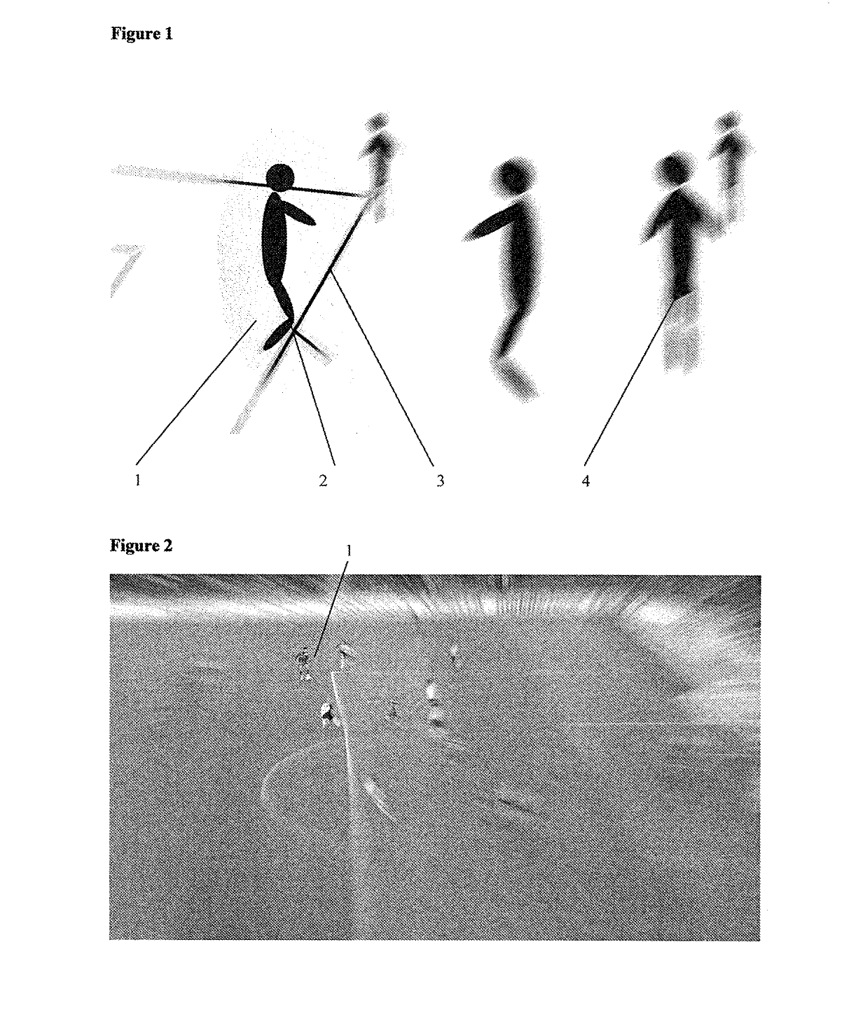

A schematic example of an image is depicted in FIG. 1. The example relates to a scene in a football (soccer) game. The ROI 1 is defined by an ellipse around a chosen player 2. Objects that are physically close to the player—such as a portion of a penalty area line 3 which on the 2D image or in 3D is around the player—are in focus, while more remote objects such as remote portions of the line 3 or other players 4 are subject to a motion blur during a camera transition.

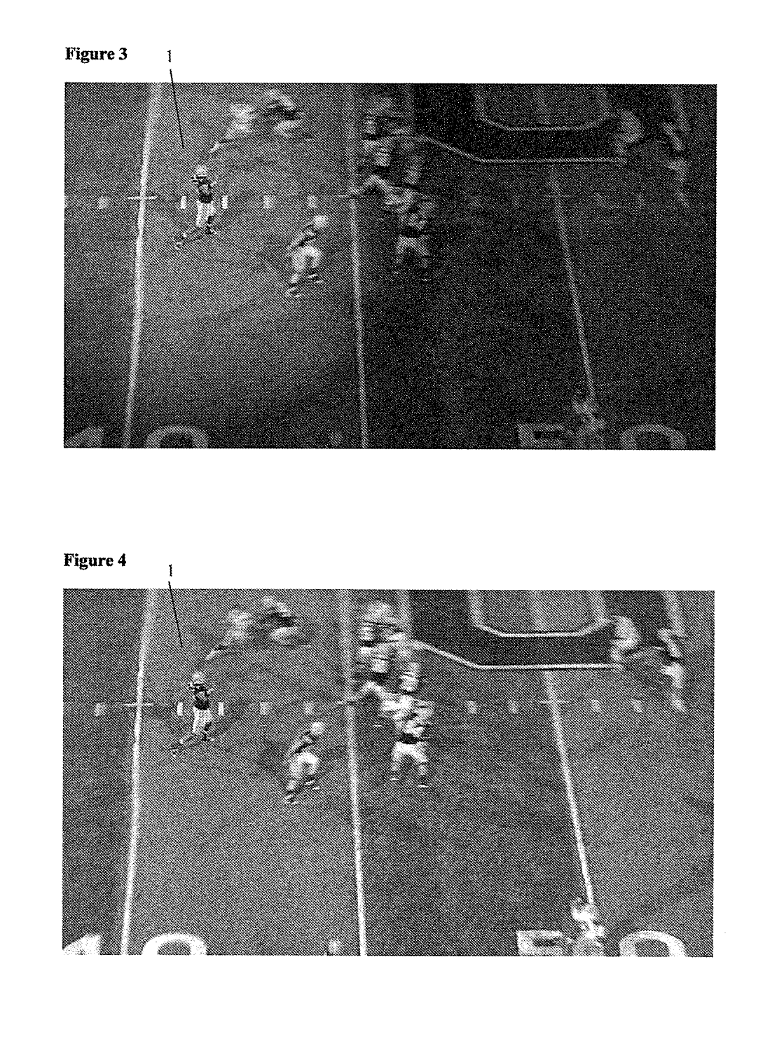

FIG. 2 shows a scene from a football (soccer) game with a player having the ball being in the ROI 1 and being in focus and more remote areas being subject to motion blur. Also, it can be seen that a black-and-white player close to the penalty line is almost in focus because of being in the transition region, while other, further away players are fully out of focus.

FIGS. 3 and 4 show a scene of an American football game with a red dressed player on the left defining the center of the ROI. In FIG. 3, the default area is, in addition to the motion blur, also shadowed to more prominently emphasize the ROI 1; the circular ROI 1 and the transition region around it are clearly visible.

An example relating to a sports event on a playing field defining a ground plane is described hereinafter. The ROI is chosen by drawing, with a drawing pen, an approximate ellipse on an image by hand. Into this, a mathematical ellipse approximating the drawing ellipse as well as possible is fitted. The ellipse is than projected onto the ground plane. The ellipse on the floor is then projected into the (real or virtual) camera. From a previous calibration, the relationship between the pixel number and the actual distance (in metres) is known. The transition region may be defined to be a certain region around the ellipse in on the ground (for example 3 m around the ellipse) or may be a certain pixel number (such as 100 pixels) around the ROI projected into the virtual camera. In the former case, the transition region automatically adapts if the camera for example zooms in, in the latter case it does not.

The image effect in this example is a motion blur applied to the background (to the default region, and, in part, to the transition region.). The motion blur is a combination of a velocity blur (see for example Gilberto Rosado. Motion Blur as a Post-Processing Effect, chapter 27. Addison-Wesley Professional, 2007.) in which the velocity is the parameter, and an accumulation motion blur (the averaging of the last n images, with n being a parameter). In the transition region, the respective parameter (the velocity v, the number n of images) is continuously varied from the value of the default region to 0 and 1, respectively, at the interface to the ROI.

1. A method of processing image data, comprising the steps of:
providing an image sequence, the image sequence being one of a video sequence, a camera transition of a constant image, and a camera transition of a video sequence,
identifying a region-of-interest in at least one image of the image sequence,
defining a transition region around the region-of-interest and defining a remaining portion of the image to be a default region or background region,
applying at least one image effect with at least one parameter to the region-of-interest or the default region, including applying different image effects to the region-of-interest and the background region or of applying the same image effect to the region-of-interest and the default region but with different parameters,
applying the at least one image effect to the transition region with the at least one parameter being between a parameter value of the region-of-interest and a parameter value of the default region.

2. The method according to claim 1, wherein in the step of applying at least one image effect to the transition region, the parameter value or at least one of the parameter values in the transition region changes continuously as a function of position.

3. The method according to claim 1, comprising the steps of:
wherein the image sequence represents a scene, of which 3D data is available,
using the 3D data to identify the region-of-interest in images of the image sequence,
applying at least one image effect to the region-of-interest or the default region.

4. The method according to claim 3, wherein the image effect or at least one of the image effects is applied to one of the region-of-interest and the default region and is not applied to the other one of the region-of-interest and the default region.

5. The method according to claim 1, comprising the steps of
determining a start and an end camera of a camera transition,
creating the camera transition,
providing at least one parameter for an image transition of the region-of-interest or of the default region, wherein optionally different parameters may be provided per element of the region-of-interest,
applying the image effect with the parameter or parameters being spatially adaptive, to one of the region-of-interest and of the default region and, if applicable, to the transition region and not applying the image effect, or applying the image effect to a reduced extent, to the other one of the region-of-interest and the default region.

6. The method according to claim 5, comprising, prior to applying the image effect, the step of defining a transition region between the region-of-interest and the default region, wherein the image effect or at least one of the image effects is applied to the transition region with a parameter value or with parameter values being between the parameter value of the region-of-interest and of the default region.

7. The method according to claim 1, wherein the region-of-interest is defined by a user or is calculated based on additional data not being part of the image sequence.

8. The method according to claim 1, wherein the image sequence represents a scene on a essentially plane ground, and wherein the region-of-interest comprises an environment, projected onto the ground, of an object being part of the scene.

9. The method according to claim 1, wherein the image effect comprises motion blur.

10. The method according to claim 1, wherein the image effect comprises a depth of field.

11. The method according to claim 1, wherein the image effect comprises a shading.

12. The method according to claim 1, being computer-implemented.

13. A computer system comprising a processor and at least one input/output device, the computer being programmed to perform a method according to claim 1.

14. A computer program stored on a computer readable medium and comprising: computer readable program code that causes a computer to perform the method of claim 1.

15. A virtual replay unit for image processing for instant replay, comprising one or more programmable computer data processing units and being programmed to carry out the method according to claim 1.
